(19) United States
(12) Patent Application Publication
(10) Pub. No.: US 2009/0024699 A1
(43) Pub. Date: Jan. 22, 2009

(54) INTEGRATION OF A MEDICAL WORKSTATION INTO A CLIENT-SERVER SYSTEM

(76) Inventor: Mario Eichenseer, Pinzberg (DE)

Correspondence Address: SCHIFF HARDIN, LLP;PATENT DEPARTMENT, 6600 SEARS TOWER, CHICAGO, IL, 60606-6473, US

(21) Appl. No.: 12/175,817

(22) Filed: Jul. 18, 2008

(30) Foreign Application Priority Data
Jul. 20, 2007 (DE) 10 2007 033 901.3

(51) Int. Cl. G06F 15/16

(52) U.S. Cl. 709/203

(57) ABSTRACT

In a method, a system and a computer program product for electronic data processing, communication and/or data retention in a computer-supported medical technology system to which multiple modules are connected that are involved in data exchange via a computer network, local workstations are thereby integrated or incorporated into a client-server system. A workstation thus embodies a client component and a workstation component. The client component serves for access to the central server. The workstation component serves for access to the local data of the workstation. Data exchange via the server with automatic synchronization occurs among all modules, in particular between the client component and the workstation component, such that consistent data sets are always stored and processed.

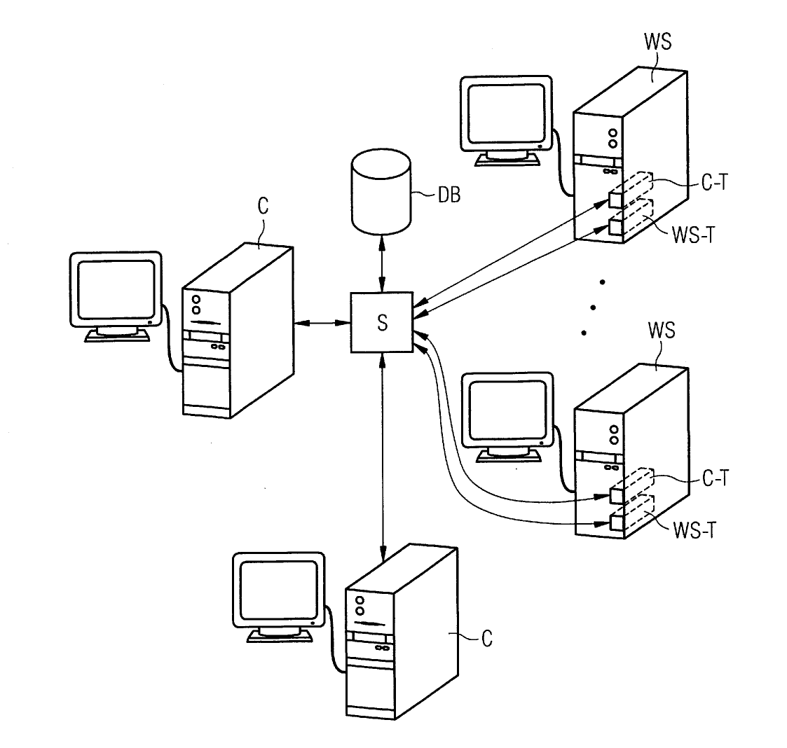

### BACKGROUND OF THE INVENTION

1. Field of the Invention

The present invention is in the fields of medical technology and data processing and in particular concerns a method, a system and a computer program product (computer-readable medium encoded with programming instructions) for electronic data exchange and/or for data retention in a computer-based medical technology system, wherein the system is designed as a client-server system, and wherein it should be possible to connect additional workstations.

2. Description of the Prior Art

In medical technology computer-based systems that are based on an electronic data processing, it is conventional to use individual workstations as standalone systems. All necessary applications with all necessary data were locally loaded or, respectively, installed on these (normally relatively complex and comprehensive) workstations.

A transition occurred incrementally to what are known as client-server systems in which a central server is involved in data exchange with a plurality of clients in order to provide messages and/or applications or services. Depending on the employed concept and the underlying computer architecture, it is possible to have more or less complex tasks executed on the respective clients. If the configuration of the clients (type and scope of the installed software) is very low, it is called a thin client. If the respective client can access a relatively comprehensive configuration, it is called a fat client. The client-server model is thus based on a distributed system with multiple electronic modules that are respectively involved in data exchange. In addition to the flexibility, the advantage of the client-server systems is also apparent in that, among other things, the load of the respective communication partner can be dynamically controlled and optimized for the application case.

Due to the technological background, some medical technology systems require the use of a singular workstation, as before. However, in order to utilize the advantages of the client-server model, such client-server systems are increasingly used in existing systems. This makes it necessary to integrate existing workstations into client-server systems, wherein the wait time of the user (here: the radiologist) should be reduced. Many modern systems are therefore located in what is known as a migration phase in which the previously typical workstation concept should be transitioned to the client-server concept.

### SUMMARY OF THE INVENTION

The invention is for use in such medical technology systems in which the client-server concept is to be applied in addition to the previous workstation approach. However, this combined concept (combination of workstation and client-server approach) leads to a series of problems that are primarily reflected in an absent or manually required synchronization of the data which can lead to far-reaching consequences, for instance locally modified data of a patient on a workstation are not traceable back to a central server. There are then inconsistent patient data sets that, under the circumstances, can lead to serious errors or, respectively, misdiagnoses. Each workstation is normally equipped with a separate database. In conventional systems, this database of the respective workstations is involved in an automatic, synchronized data exchange neither with other databases of the other workstations nor with a database of the central server. In such conventional systems, this means that the respective data sets must be manually compared or synchronized, which in practice has proven to be a very problematic procedure (since it is prone to error).

An object of the present invention has therefore posed the object to improve the integration of local workstations in a client-server system, and in particular to automatically synchronize the data exchange between all modules of a client-server system into which singular workstations are also incorporated.

This object is achieved in accordance with the invention by a method, system and computer program product for electronic data exchange, for proximity and/or for data retention in a medical technology system that is based on a client-server concept, in which system individual workstations are integrated, wherein an automatic synchronization is provided between all connected clients, all connected workstations and/or the central server.

The achievement of the object according to the invention is subsequently described using the method. Features or alternative embodiments and/or advantages that are mentioned in connection with the method are also applicable to the system and/or the computer program product and vice versa. In other words, the system and/or the computer program product can be developed with the features mentioned in this context or with features from the sub-claims regarding the method and vice versa. The corresponding functional features of the method are developed by corresponding hardware modules of the system.

The method according to the invention serves for electronic data processing, for data exchange and/or for data retention in a computer-based medical technology system and comprises the following modules that are involved in data exchange via a computer network:

at least one central server that provides services (or, respectively, applications) and/or data,

a number of medical technology clients that respectively access the data stored on the server or on a database connected with the server and/or services provided via the server,

a number of medical technology workstations on which local services are respectively provided and/or on which local data are respectively stored.

In accordance with the inventive method, a client for data exchange with the central server is installed on all or on selected workstations, such that these workstations (thus the workstations on which a client is installed) embody a client component that acts as a client of the server; and wherein these workstations embody a workstation component that acts as a local workstation (standalone component); and wherein a data exchange and an automatic synchronization are executed at least indirectly between all modules, and in particular between the client component of the workstation and the server. In a preferred embodiment of the invention, there is no direct data connection between client and workstation. A data exchange always ensues between server and workstation. The client is therefore installed on the workstation. There is also no direct data interface between the client part and the workstation part of the workstation. The communication here ensues via the central server.

In other words, the method according to the invention is intended to integrate one or more workstation(s) into a client-server system, wherein an automatic synchronization of the data is executed, and wherein all previous functionalities of the system are provided, in particular a data exchange, a data processing and/or a data retention in the respective environment.

The primary field of application lies in the field of medical technology and concerns (for example) systems that are used in a clinical facility (for example radiology, other fields of imaging data processing or other departments). However, it is likewise possible to apply the concept according to the invention to other technical fields, in particular logistics, automobile engineering, production engineering or other fields of engineering in which it is necessary to successively remodel the previous workstation concept into a client-server model.

The data exchange can ensue according to arbitrary protocols (for example DICOM) and in the form of transferred messages of the most varied content, signals or the like. Modules (among other things server, clients, workstations etc.) in use can be both software modules and hardware modules or a combination of the two.

A (central) server is typically used in order to provide an access to the special services or, respectively, service providers that are provided to the clients. For this purpose, the server is involved in data exchange with the respective client or, respectively, the client program that is installed on the respective application computer (the client). Depending on resources and capability of the respective server, complex applications can be provided here for use. As already mentioned, the server comprises a software aspect and/or a hardware aspect. It is possible that multiple applications (thus multiple server applications) are installed on a server.

Moreover, it is possible for multiple computers to be interconnected into a network that then acts as what is known as a server cluster. The cluster concept is primarily used when the individual hosts do not sufficiently possess the necessary computing resources and a combination of resources is required. In the other case, thus in the event that a very powerful host is available, for the solution according to the invention it is likewise possible to use a computer or, respectively, host on which multiple servers are installed. This is also designated as what is known as a virtual server. The procurement the respective data or applications for the user thus remain encapsulated or, respectively, concealed. The user does not have to care from where he procures the respective applications (services) or data. This clearly simplifies the handling of the respective system.

The services are executable files (for example .exe), applications or, respectively, tools. They are normally data processing programs in the field of medical technology such as, for example post-processing programs, workflow tools etc. However, other usage fields (for example administration or non-medical/clinical tools) are also conceivable here. Moreover, the server prepares the data for data processing. A database in which the data are stored is normally provided for this. The database is connected to the central server. It is likewise possible to provide multiple other data stores here or to also connect the database to the local workstation.

The clients are likewise programs that are installed on a computer in order to be able to access the serves and/or data of the server. The clients thus represent the access to the data or serves of the server. The workstations on which the client is installed are differentiated according to where the data retention and/or data processing occur: a client can thus be fashioned as a fat client or as a thin client. A thin client is normally merely equipped with a user interface (for example in the form of a browser) while the actual program logic remains on the application server. Depending on the application field, it is possible to assign more or fewer tasks to the client. In one case, even the operating system of the client lies on the central server. The services or applications are then loaded over the network just like the operating system. Furthermore, given very resource-poor clients it is also possible to have only the task of the started program or, respectively, of the started application show on a monitor while the actual data proximity is executed on the server. Here the client thus possesses only an I/O interface for input and output of the data for data processing. A dynamic shifting of task ranges between the central server and the respective client is advantageously possible, such that it is additionally scalable to a high degree and on the other hand requires very little maintenance since maintenance tasks on the applications must be executed only on the central server. Overall, the administration expenditure can also be decreased since all administration tasks must merely be executed once at a central location and all clients can take advantage of this.

The data processing is executed locally in part on the respective client and in part on the server. Here what are known as frameworks can be resorted to that offer a platform so that the respective user can himself assemble the required modules or, respectively, plug-ins.

Moreover, the control, the administration and/or additional task areas are addressed in multi-layer architectures. However, the underlying concept of the present invention can be executed independent of the respective selection of the client-server system. This leads to a clear flexibility gain.

The workstations are medical technology computer-based workstations with locally provided services and locally stored data. It is likewise possible that a local database is connected to a workstation. However, according to the invention it is additionally possible that a remote client is installed on a workstation, such that two different application portfolios or, respectively, service portfolios are provided on the respective workstation: 1. the service portfolio of the local workstation (which is also designated as a workstation part in this invention) and 2. The portfolio of the server that is accessible via the client (which is also designated as a client part in this invention). The preceding also applies to the data. The workstation part of the examination subject thus concerns the local services and the local data or, respectively, databases while the client part of the workstation pertains to services provided on the server and data provided via the server. According to the invention, a data exchange between the workstation part and the client part of the respective workstation is provided via the central server so that an automatic synchronization of the processed data can be executed. It is therefore ensured that the correct data set is always calculated with and consistent data are always stored in the system. Naturally, the data exchange can also be ensured between the other modules of the system, thus also between the workstation part of the respective workstation and the central server.

According to the invention, the workstations previously in use can now be used in order to install a client. This can ensue either on all or on selected workstations.

In a preferred embodiment of the invention, data information and/or application information are provided on the respective workstation or on the respective client. The data information inform about the storage location of requested data. The application information informs about the applications or services that can be accessed from the respective workstation or, respectively, that can be executed here. The application information comprises license information and/or additional application-specific information. The license information informs about, for example, the number, the scope, the date and possible additional information of the licensed applications on a workstation.

In each case, a license interrogation functionality is provided on the central server, which functionality checks the services or applications on all workstations integrated into the network regularly or at predefinable points of time and provides this information in a form intelligible to the user. This can ensue in the form of icons that can be presented on the user interface or in the form of tabular menu entries.

In a further preferred embodiment, a user interface is provided that allows the variable appearance of icons and menu entries of services.

In a further preferred embodiment, an automatic patient data interrogation functionality is provided that checks whether requested patient data are already present or, respectively, stored locally, or whether these have to first be requested from other modules. In the event that the latter is the case, the data are automatically requested from the respective module and then provided.

In a further preferred embodiment, a control functionality is provided that controls a remote workstation so that, for example, requested services can be started and/or requested data can be loaded and/or additional steps can be initiated.

In a less complex embodiment, the control functionality mentioned in the preceding is replaced by a load functionality. The load functionality serves to automatically initiate a loading of remotely stored data and/or of remotely installed services in the event that the requested data and/or the requested services are not locally available on the respective mode. This has the advantage that the user no longer has to know where (on which workstation) which data and where which services are provided. The loading of the requested data and/or the requested services ensues automatically via the client-server network.

In a further preferred embodiment, a communication functionality is provided that automatically initiates a query to the user upon a storage command of data and asks the user whether the data should be relayed to other instances of the system or, respectively, modules. In the event that the user confirms this with a corresponding input via the user interface, the data are automatically relayed to the respective instance. If necessary, this functionality can be further expanded in that the data are automatically sorted into a defined data structure.

In a further preferred embodiment, the method comprises a delete functionality. This is normally provided at the respective workstation. It can be activated as needed and causes the locally processed data to be deleted from a local memory. However, the deletion is only executed after either the user has confirmed a corresponding deletion request or via the user interface or after a confirmation signal that the respective data have been stored in the central server has been received from the central server. This delete functionality after a confirmation signal can increase the security of the system overall and greatly improve the local storage resources in that a redundant data storage is avoided.

In a further embodiment, a processing functionality is provided. The processing functionality enables data (in particular patient data of a currently loaded patient) to be read out and these to be relayed to the respective application for processing of said data. For example, if raw data of a CT scanner should be processed further, a matching service (for example reconstruction) is automatically offered to the user by the functionality. If multiple services are applicable, this is communicated to the user via a selection of a services (for instance in the form of a list) so that the user can select one or more services.

The underlying client-server principle is very flexible and also enables the following application cases, which provide a special application on a module. For example, a special application (for example a cardiological image data processing) can be installed on a specific workstation. Via the client-server concept according to the invention, in which even solitary workstations are integrated, the data processing and/or the data retention can be clearly made more flexible and simple so that even another workstation or a client can use the special application (cardiological application).

A system in accordance with the invention, for electronic data exchange, data processing and/or data retention, has the following computer-based medical technology modules that are involved in data exchange via a computer network:

at least one central server that is designed to provide services and/or data,

a number of clients that are designed to access respective data stored on the central server and/or on a database connected with the server and/or services provided on the server and

a number of workstations on which respective local services are provided and/or that have a local data storage that is designed to store data.

In this system, a client for data exchange with the central server is installed on all or on selected workstations, such that the workstation has a client component that functions as a client of the server. The workstation has a workstation component that functions as a local workstation. Data exchange and an automatic synchronization with the server are respectively provided between all modules, at least indirectly, and in particular between the client component and the workstation component of the workstation.

### BRIEF DESCRIPTION OF THE DRAWINGS

The single FIGURE is an overview representation of modules that are used in the method according to the invention and in the system according to the invention according to a preferred embodiment of the invention.

### DESCRIPTION OF THE PREFERRED EMBODIMENTS

The modules are schematically presented in the FIGURE. A central server S is connected to a plurality of workstations C, WS. One or more databases DB can likewise be connected to the central server S. The workstations can be fashioned as singular workstations WS or as workstations on which a client C is installed. The client C is normally a software program that is installed on an arbitrary computer-based workstation and enables access to the central server S.

The workstations are normally workstations or parts thereof that have already been previously located in the medical system. They are thereby typically standalone systems with a local data retention (for example a connected local database) and with local applications that are used on the respective workstation WS.

According to the invention, a client C can likewise possibly additionally be installed on a workstation WS, which client C enables the access to the central server S.

According to the invention, a workstation WS on which a client C is installed thus has two parts:

1. a client C-T that acts as a client of the server S and

2. a workstation part WS-T that acts as a local, singular workstation.

The workstation part WS-T typically concerns the conventional, previous workstation with its computer configuration and serves for access to local data and/or local applications. The client part C-T on the workstation and the workstation part WS-T do not communicate directly but rather do so indirectly via the server.

In a preferred embodiment, the client C is a network node of the computer network that transfers or, respectively, relays a task or, respectively, a service to the local node or to another node. For example, the client C can exist in a web browser that communicates with a central server program. Moreover, it can be an object that accesses another object by calling methods. The location of the respective data processing is thus flexible. The operating system can distribute the tasks or the services to be executed such that as optimal a loading of the system as possible can be achieved. Moreover, it is possible that a user can also use applications and data of other, remote workstations at a local workstation, which enables a further flexibility advantage. The data processing and/or the data retention thus ensue in part at the client C and in part at the server. The corresponding distribution between client C and server S can be flexibly handled.

The following scenarios according to the invention can now be used.

A user (for example a physician) works with loaded data sets of a patient A at a local workstation WS on which a server client [sic] C is installed. If the physician would now like to execute or apply a specific data processing on the data set of the patient A, it is helpful if the physician is informed of on which workstation the specific post-processing functionality he desires is provided. Moreover, it is helpful if he is informed about whether the post-processing functionality he desires can also be used on precisely the workstation at which he presently operates. For this purpose, according to the invention that the user is informed (via application information, license information and/or further application-specific information) of on which workstations WS which functionalities or, respectively, services are provided with which licenses. The system automatically initiates a query of the provided services with the respective licenses and stores these so that this information is provided to the user via corresponding symbols or other data sets. In the preferred embodiment, this ensues via an icon on the screen. In the preferred embodiment, the method according to the invention implements such an interrogation at predefinable (for example regular) intervals. All services, in particular all post-processing functionalities with their respective tools and applications that are available on the respective workstation WS, are shown on the user interface of the respective server client C or are visible via a menu entry. If the physician now desires a specific tool for what is known as a heart data post-processing, for example, he automatically receives information about the workstation WS in which this desired special software is installed. This typically ensues in the form of a list. However, here other formats are conceivable. The physician can now search for a workstation WS from this list and select said workstation WS. Typically, the physician will select the workstation that he or she is presently operating. It is therefore no longer necessary that a physician must physically go to this workstation WS that provides the specific post-processing functionality; rather, he can also apply all possible functionalities on site via the server.

After selection of the respective processing workstation WS, a query is automatically sent from the server S to this workstation WS. The query initiates a check as to whether the required patient data of the currently loaded patient A can also be provided for the purposes of processing. In the event that this is not the case, the data are sent from server S to the workstation WS, and a loading of the respective requested patient data (in this case the patient data of the patient A) is automatically initiated so that the respective data to be processed are also available at the respectively sought workstation WS.

In the meantime the selected workstation WS automatically starts the corresponding selected tool (the respective service) and locally provides the user (at his or her workstation WS) with a corresponding user interface. Moreover, the loading process for the requested patient data is automatically begun.

An additional SW functionality is provided for this that is designed exclusively for communication between workstations WS and reproduces the data of a first workstation on the screen of a second workstation. This occurs via an additional client (however, this is a different client—typically here a thin client—than that which the central server accesses).

Multiple workstations WS for processing of the respective data are typically available, such that the user must select a workstation WS from the set of those possible. However, it is also possible that only one workstation WS has loaded the specific service. In this case, the data transfer ensues automatically to this network node. The physician can then execute the respective service and process the patient data as desired. The result of the data processing (for example new or modified result images, newly generated image stacks, newly generated or modified reports etc.) are automatically sent to the central application server S and stored there together with the original data sets of the respective patient A that are already present. With this it is ensured that a consistent data set is always present in the system and a manual synchronization is no longer required.

After the data processing (local or remote) and the data storage, the user interface of the server client C is brought into the foreground again via a simple click or other operation of the user interface. Moreover, it is possible that the server S and/or the workstation WS automatically offers to load the newly arrived data.

A different scenario is likewise possible that is targeted at the situation that the data to be processed are not present on the local workstation WS.

For example, the physician has loaded data sets of the patient B onto the workstation, which data sets he would like to process with one of multiple determined services. For this purpose, the user operates an actuation element of the user interface (normally by pressing a button or operating the mouse) of the respective workstation WS in order to load or, respectively, to activate or to start the client part C-T of the respective workstation WS. At the same time, a query about the client part C-T, as to whether the specific data of the respective patient B are present there, is sent to the central server S. In the event that this is not the case, these are automatically sent from the respective local database of the workstation WS to the database DB of the server S or, alternatively, are sent from the workstation WS to the server S or, in a further alternative, the workstation WS actively requests the data from the server S. As soon as the data are loaded onto the central server S (or were already present there), they are automatically loaded. Moreover, a user interface is started at the respective workstation WS (alternatively, the user interface was already opened and was started at an earlier point in time), which enables the user to see the data loaded onto the central server S. These can thereupon be processed. This is possible in that the user controls or, respectively, initiates a processing on the central server S or on another workstation computer WS, C (remotely, so to speak) on the local workstation WS via a provided user interface.

After the data processing, an automatic storage of the processed data ensues. For this a query as to whether the processed data should additionally also be written back to the point of origin (for storage on the central server S or, respectively, in its database DB) or not (namely, when the data were not locally present on the central server S but rather must first be loaded from a remote workstation WS) is therefore automatically output to the user. Depending on the response to this question by the user, a storage of the data ensues on the central server S (or the database DB connected to it) and/or on at least one of the workstations WS.

As will be apparent to those skilled in the art, the invention can be realized partially or entirely in software and/or hardware and/or distributed on multiple physical products (computer program products).

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for electronic data processing, data exchange and/or data retention in a computer-supported medical technology system comprising modules involved in data exchange with each other via a computer network, including at least one central server that provides services and/or data, a plurality of clients that respectively access data stored on the server or in a database associated with the server, and/or services provided by the server, and a plurality of workstations at which local services are respectively provided and/or in which local data are respectively stored, said method comprising the steps of:
installing a client for data exchange with the central server in at least some of said workstations in said plurality of workstations, thereby providing said workstations with a client component functioning as a client of the server and a workstation component functioning as a local workstation; and
implementing data exchange and automatic synchronization indirectly between all of said modules including between the client component of said at least some of said workstations and said server.

2. A method as claimed in claim 1 comprising executing local services at the respective workstations, and executing selected remote services via the respective client components.

3. A method as claimed in claim 1 comprising accessing locally stored data and/or remotely stored data from any of said workstations.

4. A method as claimed in claim 1 comprising providing application information at each workstation and/or at each client, and using said application information to determine which data can be accessed from the respective modules.

5. A method as claimed in claim 4 comprising selecting said application information from the group consisting of license information and additional application-specific information.

6. A method as claimed in claim 1 comprising, from a control entity, automatically initiating loading of remotely stored data and/or a control of remote modules among said modules, to start and/or execute requested services if requested data or requested services are not locally available at a respective workstation.

7. A method as claimed in claim 1 comprising activating a delete function to remove locally processed data from a local memory after said locally processed data have been stored in said central server.

8. A method as claimed in claim 1 comprising activating a relay function to relay locally stored or processed data from one module to another module.

9. A system for electronic data processing, data exchange and/or data retention in a computer-supported medical technology system comprising:
modules involved in data exchange with each other via a computer network, including at least one central server that provides services and/or data, a plurality of clients that respectively access data stored on the server or in a database associated with the server, and/or services provided by the server, and a plurality of workstations at which local services are respectively provided and/or in which local data are respectively stored;
a client for data exchange with the central server installed in at least some of said workstations in said plurality of workstations thereby providing said workstations with a client component functioning as a client of the server and a workstation component functioning as a local workstation; and
said modules being configured to implement data exchange and automatic synchronization indirectly between all of said modules including between the client component of said at least some of said workstations and said server.

10. A system as claimed in claim 9 comprising the respective workstations being configured to execute local services, and the respective client components being configured to select remote services.

11. A system as claimed in claim 9 wherein said workstations are configured to access locally stored data and/or remotely stored data from any of said workstations.

12. A system as claimed in claim 9 wherein each workstation and/or at each client is provided with application information, and is configured to use said application information to determine which data can be accessed from the respective modules.

13. A system as claimed in claim 12 wherein said application information is selected from the group consisting of license information and additional application-specific information.

14. A system as claimed in claim 9 comprising, a control entity configured to automatically initiate loading of remotely stored data and/or a control of remote modules among said modules, to start and/or execute requested services if requested data or requested services are not locally available at a respective workstation.

15. A system as claimed in claim 9 comprising a local memory, and wherein said central server is configured to activate a delete function to remove locally processed data from the local memory after said locally processed data have been stored in said central server.

16. A system as claimed in claim 9 wherein said central server is configured to activate a relay function to relay locally stored or processed data from one module to another module.

17. A computer-readable medium encoded with programming instructions for electronic data processing, data exchange and/or data retention in a computer-supported medical technology system comprising modules involved in data exchange with each other via a computer network, including at least one central server that provides services and/or data, a plurality of clients that respectively access data stored on the server or in a database associated with the server, and/or services provided by the server, and a plurality of workstations at which local services are respectively provided and/or in which local data are respectively stored, said programming instructions causing:
installation of a client for data exchange with the central server in at least some of said workstations in said plurality of workstations, thereby providing said workstations with a client component functioning as a client of the server and a workstation component functioning as a local workstation; and
implementation of data exchange and automatic synchronization indirectly between all of said modules including between the client component of said at least some of said workstations and said server.
